(19) United States
(12) Patent Application Publication
(10) Pub. No.: US 2007/0278212 A1
(43) Pub. Date: Dec. 6, 2007

(54) ELECTRONIC DEVICE AND METHOD OF MANUFACTURING AND ELECTRONIC DEVICE

(76) Inventor: Katsuyuki Okimura, Tokyo (JP)

Correspondence Address: HAYES SOLOWAY P.C., 3450 E. SUNRISE DRIVE, SUITE 140, TUCSON, AZ, 85718, US

(21) Appl. No.: 11/753,448

(22) Filed: May 24, 2007

(30) Foreign Application Priority Data
Jun. 2, 2006 (JP) 2006-154904
Jun. 19, 2006 (JP) 2006-169163
Sep. 26, 2006 (JP) 2006-260343

(51) Int. Cl. H05B 3/06

(52) U.S. Cl. 219/540

(57) ABSTRACT

An electronic device includes a heating structure including a sub-mount for mounting an LED chip thereon, a first solder layer for bringing the LED chip and the sub-mount into junction and a heat releasing structure including a first metal layer and a graphite layer stacked onto the first metal layer, wherein the heating structure is mounted on the graphite layer side of the heat releasing structure. The electronic device includes a second metal layer being present on a plane in the graphite layer opposite to a plane where the first metal layer is stacked; and the second metal layer and the sub-mount are brought into junction with a second solder layer so that the heating structure and the heat releasing structure are thereby brought into junction.

### BACKGROUND OF THE INVENTION

1. Field of the Invention

The present invention relates to electronic devices which diffuse and radiate heat from heating elements with graphite and a method of manufacturing electronic devices.

2. Description of the Related Art

Efficient radiation of heat generated by pyrogenic parts is extremely important for preventing parts from malfunctioning and for ensuring longevity of products. Therefore, conventionally, various kinds of heat releasing material are used in electric and electronic devices having parts accompanying heat generation. In particular, in recent years, as progress is made in reducing the size and improving the sophistication and performance of electronic devices, graphite sheets made of graphite as main material are used in order to efficiently release heat generated from large-scale integrated CPU or LED. A graphite sheet is thermally anisotropic and has a good heat conductive property in the of plane direction. Therefore, a graphite sheet instantly conducts locally generated heat in the plane direction when an LED is operating and allows expansion of the surface of the graphite sheets or allows the effective heat radiation area of the heat releasing member to be brought into junction with the graphite and can attain high heat radiation efficiency.

Heat diffusion by a graphite sheet with such a property will be described with reference to a schematic section on an electronic device comprising a graphite sheet provided with an LED chip illustrated in FIG. 1 mounted thereon.

Electronic device 100 has heating structure 110 configured by mounting LED chip 104 on sub-mount 103 on heat releasing structure 120 consisting of metal layer 101 and graphite layer 102. LED chip 104 and sub-mount 103 are brought into junction with hard solder 106a such as AuSn. Heat releasing structure 120 and heating structure 110 are brought into junction with soft solder 106h made of Sn and the like that have a lower meeting point than hard solder 106a. LED chip 104 is coated with resin not illustrated in the drawing.

A schematic route of heat transfer in electronic device 100 structured as above is as follows.

Heat generated by operation of LED chip 104 is conducted through hard solder 106a and transferred to sub-mount 103. The heat transferred to sub-mount 103 is conducted through soft solder 106b and is transferred to graphite layer 102. The heat transferred thus in the stacking direction is conducted in the plane direction in graphite layer 102. The heat widely diffused in the plane direction in graphite layer 102 is transferred to metal layer 101 and efficiently diffused in the air from the surface of metal layer 101.

In the case where graphite layer 102 is not present so that heating structure 110 is directly brought into junction with metal layer 101, the heat transferred from sub-mount 103 to metal layer 101 is mainly conducted in the thickness direction rather than in the plane direction. Therefore, even if the area of metal layer 101 is widened in order to improve the heat releasing property, sufficient heat releasing effect will not be not attainable.

However, disposing graphite layer 102 to intervene between sub-mount 103 and metal layer 101 to improve the heat conductive property in the plane direction, the effective heat radiation area will be widened in metal layer 101 to enable heating element such as an LED to cool efficiently.

In addition, an LED package with highly heat conductive carbon material containing, as main material, carbon that is expected to attain high heat diffusion properties, such as a graphite sheet, is disclosed, for example, in Japanese Patent Laid-Open No. 2006-86391.

The LED package disclosed in Japanese Patent Laid-Open No. 2006-86391 has a basic structure similar to the one illustrated in FIG. 1. FIG. 2 illustrates a section of a main portion of the LED package disclosed in Japanese Patent Laid-Open No. 2006-86391.

LED package 210 comprises frame metal base 211, LED chip 212, and insulating member 214 leading lead member 213 to be connected to LED chip 212, and is configured by mounting LED chip 212 on metal base 211 present in a predetermined location with a solder material or an adhesive agent so that it comes into direct contact with highly heat conductive carbon material 216.

Metal base 211 consists of mortar-like side wall member 218 and bottom plate member 219. Insulating member 214 forms opening 215 and is provided with an electrically conductive pattern for outward derivation. LED chip 212 is mounted on high heat conductive carbon member 216, directly brought into junction thereon, disposed in opening 215 in the bottom plate and is connected to lead member 213 by wire bonding 217 via electrically conductive pattern for outward derivation. Metal impregnated carbon material (MICC) is used as highly heat conductive carbon material 216, which is specifically obtained by burning carbon powder or carbon fiber so that solidification occurs, and by impregnating metal such as Cu or Al therein. Heat conduction is carried out by lattice vibration of a two-dimensional crystal plane of carbon, presenting high heat conductivity of 150 to 300 mW/° C.

As described above, the graphite sheet is highly heat conductive in the plane direction and therefore is effective as heat releasing material. However, solder wettability of the graphite sheet, in which carbon is used as the main material, is low and it was difficult to provide a solder layer to implement sub-mount on the graphite sheet. Therefore, although a high heat transfer coefficient can apparently be obtained by bringing the graphite sheet and the sub-mount into junction, it was impossible to realize junction between the graphite sheet and the sub-mount with the solder layer.

In a method of to mechanically bring the sub-mount and the graphite sheet into contact by screw clamp or the like, a layer of the air that functions as large heat resistance intervenes between the sub-mount and the graphite sheet microscopically and therefore, diminishes the heat diffusion property of the graphite sheet.

It is possible to eliminate the layer of the air by applying heat conductive grease between the sub-mount and the graphite sheet. However, the thermal conductivity of grease is smaller than the thermal conductivity of solder. Therefore, it is impossible to take full advantage of the heat diffusion property of the graphite sheet as well. Also, Japanese Patent Laid-Open No. 2006-86391 does not disclose how the LED package brings the highly heat conductive carbon material and the LED chip, that is a heating element, into thermal contact either. Therefore, it is hard to say that Japanese Patent Laid-Open No. 2006-86391 takes advantage of the thermal characteristics of the highly heat conductive carbon material.

Thus, significant thermal resistance will be present between the heating element and the graphite sheet in the electronic device that includes a conventional graphite sheet. Therefore, the desired cooling characteristics are not obtainable even if a graphite sheet is used.

In addition, in the case of attaining high thermal conductivity due to presence of a graphite sheet, a problem presumably takes place in the case where a plurality of elements and the like are mounted on the same substrate. For example, it is assumed that a connector is additionally mounted after the LED is mounted. In that case, heat that is applied for soldering a connector will melt solder for a LED, that has already been mounted, occasionally resulting in occurrence of displacement of the LED. Therefore, a manufacturing method will become indispensable that enables a connector to be mounted without causing the LED to be displaced in an electronic device comprising a highly heat conductive graphite sheet.

### SUMMARY OF THE INVENTION

An object of the present invention is to provide an electronic device capable of taking advantage of heat diffusion properties of graphite sufficiently.

In addition, another object of the present invention is to provide a method of manufacturing an electronic device capable of mounting a heating element and a connector onto a highly heat conductive substrate.

In order to attain the above described objects, an electronic device according to the present invention is an electronic device including heating structure mounted on the side of a graphite layer of heat releasing structure, comprising:

heating structure including a heating element, a pedestal for mounting the heating element thereon and a first connecting member containing metal for bringing the heating element and the pedestal into junction; and

heat releasing structure including the first metal layer and a graphite layer stacked onto the first metal layer, wherein

a second metal layer is present on a plane in the graphite layer opposite to a plane where the first metal layer is stacked; and

the second metal layer and the pedestal are brought into junction with a second connecting member so that the heating structure and the heat releasing structure are thereby brought into junction.

As described above, the electronic device of the present invention is provided with the second metal layer on the graphite layer to thereby enable, establishment of a junction between the heating structure and the heat releasing structure by the second connecting member. That is, by providing a member that has good wettability with solder on the graphite surface, a solder layer can be formed, for example, as the second connecting member. Thereby, thermal resistance in the heat transmission route from the heating element to the graphite layer can be reduced to enable disposition of the heat diffusion properties of the graphite layer to a sufficient extent.

In addition, the second metal layer in the electronic device of the present invention preferably contains copper or aluminum.

In addition, a surface on the side opposite to the side facing the graphite layer undergoes rust preventing process.

In addition, the heating element in the electronic device of the present invention can be an LED, a CPU and an IC.

In addition, the first connecting member and the second connecting member of the present invention can be a solder layer.

In addition, the first connecting member can be a solder bump or a gold bump.

Here the melting point of the first connecting member is preferably higher than the melting point of the second connecting member.

In addition, the pedestal can be made of AlN or SiC as the main material.

An electronic device according to the present invention is an electronic device including a heating element mounted on the side of a graphite layer of the heating structure, comprising:

a heating element and a heat releasing structure including a first metal layer and a graphite layer stacked onto the first metal layer, wherein

a second metal layer is present on a plane in the graphite layer opposite to a plane where the first metal layer is stacked; and

a wiring layer formed on the second metal layer and the heating element are brought into junction by means of a solder bump or a metal bump.

An electronic device according to the present invention is an electronic device including a heating electronic element mounted on the side of a graphite layer of the heat releasing structure, comprising:

a heating electronic element having a wiring extracting portion; and

heat releasing structure including a first metal layer and a graphite layer stacked onto the first metal layer, wherein

a second metal layer is present on a plane in the graphite layer opposite to a plane where the first metal layer is stacked;

the heating electronic element has a first plane where the wiring extracting portion is provided and a second plane where the wiring extracting portion is not provided; and

the second metal layer and the second plane of the heating electronic element are brought into junction.

As described above, the heating electronic element of the electronic device of the present invention is not provided with a wiring extracting portion on the second plane and therefore can be mounted directly onto the second metal layer without the intervention of an insulator and the like. Thereby, thermal resistance between the heating electronic element and the heat releasing structure can be reduced so as to enable exertion of the heat diffusion properties of the graphite layer to a sufficient extent.

In addition, the heating electronic element of the electronic device of the present invention is a semiconductor device and the wiring extracting portion can be a P pole and an N pole where a wire for wiring is electrically connected. In that case, the semiconductor device can be an LED.

In addition, the second metal layer and the second plane can be brought into junction by means of a solder layer.

A method for manufacturing an electronic device of the present invention is a method for manufacturing an electronic device comprising heating structure including a heating element, a pedestal for mounting the heating element thereon and a first connecting member containing metal for bringing the heating element and the pedestal into junction and heat releasing structure including the first metal layer and a graphite layer stacked onto the first metal layer, wherein the heating structure and a connector are mounted on the side of the graphite layer of the heat releasing structure, the method comprising:

forming a second metal layer on a plane in the graphite layer opposite to a plane where the first metal layer is stacked and bringing the second metal layer and the pedestal in junction with a second connecting member containing metal; and

bringing the heating element into junction with the first connecting member on the pedestal on which the second metal layer and the second connecting member have been brought into junction, and concurrently bringing the connector into junction onto with a third connecting member containing metal on the heat releasing structure.

According to the method for manufacturing the electronic device of the present invention described above, the heating element and the connector are brought into junction concurrently. Therefore, even in the case where solder layers are used as the respective connecting members, heat that is applied at the time of mounting the connector will not melt the solder layer that fixes the heating element to cause displacement.

A method for manufacturing an electronic device of the present invention is a method for manufacturing an electronic device comprising heating structure including a heating element, a pedestal for mounting the heating element thereon and a first connecting member containing metal for bringing the heating element and the pedestal into junction and heat releasing structure including the first metal layer and a graphite layer stacked onto the first metal layer, wherein the heating structure and a connector are mounted on the side of the graphite layer of the heat releasing structure, the method comprising:

forming a second metal layer on a plane in the graphite layer opposite to a plane where the first metal layer is stacked and bringing the second metal layer and the pedestal in junction with a second connecting member containing metal;

forming an insulating layer on the heat releasing structure;

forming a wiring layer on the insulating layer;

bringing the connector into junction onto the wiring layer with the third connecting member containing metal;

applying heat from the side of the first metal layer after the connector is brought into conjunction with the third connecting member onto the insulating layer to melt the first connecting member so that the heating element is brought into junction onto the pedestal; and

halting heat application from the side of the first metal layer before the third connecting member melts due to heat application from the side of the first metal layer.

Comparing the amount of time required for melting the first connecting member with heat applied from the side of the first metal layer to bring the heating element into junction onto the pedestal with the amount of time required for melting the third connecting member to bring the connector into junction with the wiring layer, the latter amount of time will become longer due to the intervention of the insulating layer, thereby giving rise to a time difference between the times. The method for manufacturing the electronic device of the present invention described above utilizes that time difference to halt heat application before the third connecting member melts. Thereby the heating element can be mounted onto the pedestal without melting the third connecting member that is used to bring the connector into junction.

According to the present invention, the second metal layer is formed on the graphite layer. Therefore, the pedestal of the heating element and the heat releasing structure can be brought into junction with the solder layer. Consequently, heat transfer from the heating element to the graphite layer will be suitable and it enables the graphite layer to apply the heat conductive properties in the plane direction to a sufficient extent and to implement heat diffusion.

In addition, according to the method for manufacturing an electronic device of the present invention, it is possible to mount the heating element and the connector onto a substrate with high thermal conductivity without confusing any displacement.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a schematic section of an electronic device comprising a graphite sheet;

FIG. 2 is a section of a major portion of an example of an LED package comprising a conventional high heat conductive carbon material;

FIG. 3 is a schematic section illustrating a configuration of an electronic device of a first embodiment of the present invention;

FIG. 4 is a schematic section illustrating another configuration of an electronic device of a first embodiment of the present invention;

FIG. 5 is a schematic section illustrating still another configuration of an electronic device of the first embodiment of the present invention;

FIG. 6 is a schematic section illustrating a configuration of an electronic device of a second embodiment of the present invention; and

FIG. 7 is a diagram for describing a method for manufacturing an electronic device in a third embodiment of the present invention.

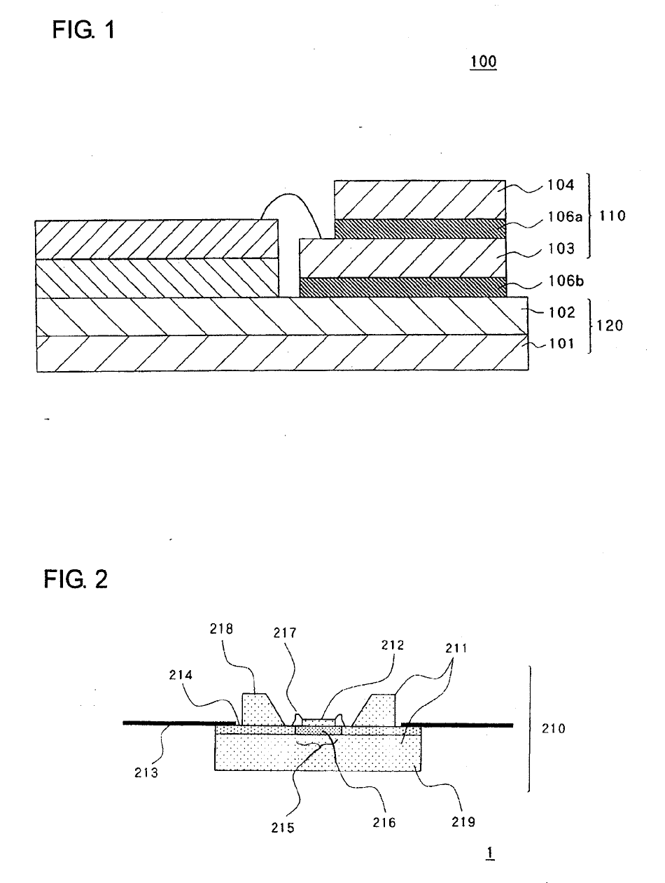

### DETAILED DESCRIPTION OF THE PREFERRED EMBODIMENTS

### First Embodiment

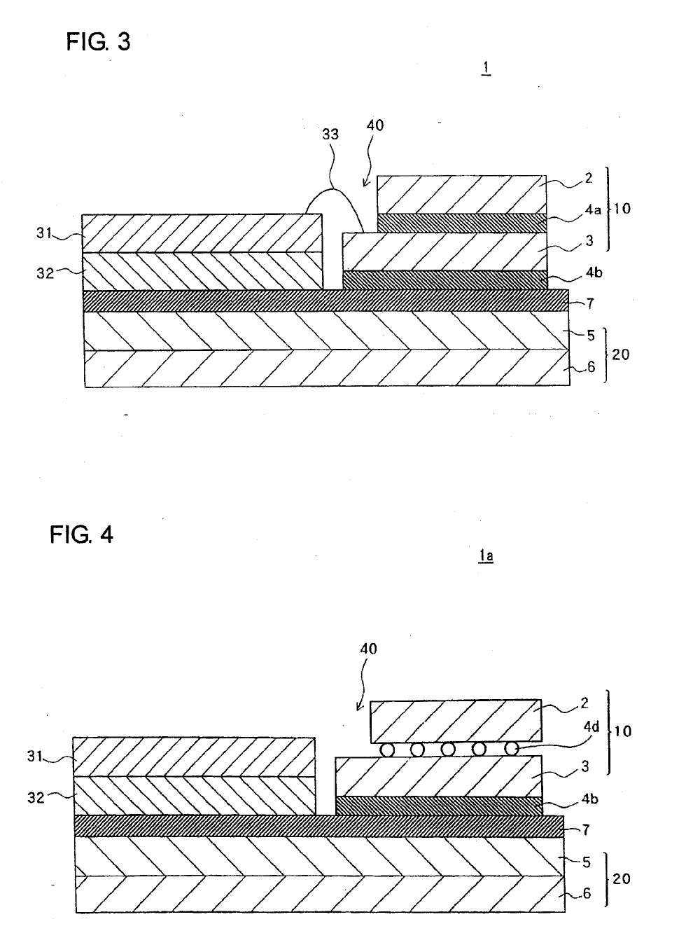

FIG. 3 illustrates a schematic section illustrating a configuration of electronic device 1 of the present embodiment.

Electronic device 1 has heating structure 10 configured by mounting LED chip 2 on sub-mount 3 on heat releasing structure 20 comprising first metal layer 6 and graphite layer 5. Second metal layer 7 is provided on graphite layer 5. Heating structure 10 and heat releasing structure 20 are brought into junction with second solder layer 4b. That is, sub-mount 3 of heating structure 10 and second metal layer 7 of heat releasing structure 20 are brought into junction with second solder layer 4b.

Heat releasing structure 20 is for diffusing heat from LED chip 2 to the exterior atmosphere and includes first metal layer 6 made of metal with good heat conductivity and graphite layer 5 with good heat conductivity in the plane direction. Graphite layer 5 is provided by being stacked on the plane on the side of first metal layer 6 where LED chip 2 is mounted.

In heating structure 10, LED chip 2 and sub-mount 3 are brought into junction with first solder layer 4a made of AuSn or the like. Heating structure 10 is arranged inside opening 40 formed in insulating layer 32 and wiring layer 31 which are stacked on heat releasing structure 20. Wiring layer 31 and sub-mount 3 are connected by wire 33. Heat releasing structure 20 and heating structure 10 are brought into junction with second solder layer 4b whose melting point is lower than first solder layer 4a. LED chip 2 is coated by resin not illustrated in the drawing.

Next, respective layers in heating structure 10 will be described.

Sub-mount 3 is a pedestal where LED chip 2 is mounted. In order that stress, distortion and the like will not take place due to difference in the heat expansion coefficient, there used as sub-mount 3 is an insulating substrate made of ceramics such as AlN, SiC and the like with good heat conductivity is used as material for sub-mount 3, this material being comparatively similar to the substrate material of LED chip 2 in the heat expansion coefficient.

LED chip 2 is brought into junction on sub-mount 3 with first solder layer 4a. As first solder layer 4a, solder made of AuSn with Au as main material is preferable. In the case of using AuSn as main material, the melting point will be approximately 280° C.

As second solder layer 4b, Sn-based solder whose melting point is lower than first solder layer 4a is preferable as second solder layer 4b.

Next, respective layers of heat releasing structure 20 will be described.

Material, for example, such as copper, aluminum and the like is used for first metal layer 6. Here, the thermal conductivity of copper is 390 (W/m·K) and the heat expansion coefficient thereof is 1.0 to 1.4 (cm²/s). On the other hand, the thermal conductivity of aluminum is 230 (W/m·K) and the heat expansion coefficient thereof is 0.9 (cm²/s).

Graphite layer 5 is a graphite sheet with graphite as the main material and “Super λ GS®: produced by Taica Corporation”, for example, is used. In the case of Super λ GS®, thermal conductivity in the plane direction is 400 (W/m·K) and the heat expansion coefficient thereof is 3.0 to 3.2 (cm²/s).

Second metal layer 7 is intended to reduce thermal resistance between heating structure 10 and heat releasing structure 20 to effectuate heat expansion properties of graphite layer 5 sufficiently. For second metal layer 7, metal film made of metal with good heat conductivity such as copper is preferably used. Even if graphite layer 5 and sub-mount 3 are to be brought into junction by means of a solder layer, wettability for both solders is not good. Therefore it is extremely difficult to bring both into direct junction by soldering. Here in the present embodiment, second metal layer 7 is provided on graphite layer 5. Thereby, wettability for solder is improved. That is, in electronic device 1 of the present embodiment, the presence of second metal layer 7 enables a junction between heating structure 10 and heat releasing structure 20 by using second solder layer 4b.

The thermal conductivity of second metal layer 7 and second solder layer 4b is generally higher than that of heat conductive grease and, therefore, can transfer heat from heating structure 10 to heat releasing structure 20 effectively. In addition, preferably second metal layer 7 is thin film that has been formed as thin as possible to such an extent as to secure workability at the occasion of stacking on to graphite layer 5 and junction to heating structure 10. Moreover, in the case of using material such as copper, that is apt to become oxidized, for second metal layer 7, a rust preventing treatment such as gold plating is preferably implemented in order to maintain heat transfer properties. Here, in the case of using aluminum for second metal layer 7, the heat conductive property is good but the for solder wettability is not good. Therefore, it is necessary to implement plating treatment on the surface so as to improve solder wettability.

Next, a method for manufacturing electronic device 1 will be described schematically.

Electronic device 1 of the present embodiment is manufactured by individually producing heat structure 10 and heat releasing structure 20 in advance, then finally, by joining them.

A method of producing heating structure 10 is as follows. First solder layer 4a made of AuSn is formed on sub-mount 3 beforehand. Subsequently, first solder layer 4a is melted beforehand. In that state, LED chip 2 is placed on first solder layer 4a. First solder layer 4a is cooled and solidified. Thereby LED chip 2 is mounted on sub-mount 3 to complete heating structure 10.

A method of producing heat releasing structure 20 is as follows.

At first, graphite layer 5 is stacked onto first metal layer 6.

Subsequently, second metal layer 7 is stacked onto a plane of graphite layer 5 on the opposite side to the plane where first metal layer 6 is stacked to complete heat releasing structure 20.

Next, insulating layer 32 and wiring layer 31 where opening 40 is formed are sequentially stacked onto second metal layer 7 of heat releasing structure 20 that includes second metal layer 7.

Next, second solder layer 4b made of Sn as the main material is formed on second metal layer 7 of opening 40. Since second metal layer 7 has good wettability with solder, second solder layer 4b is formed on second metal layer 7 in a good state.

Heating structure 10 is disposed on second solder layer 4b which has been formed as described above so that sub-mount 3 faces second solder layer 4b. Then heat is applied until the melting point of second solder layer 4b is reached. Here, since the melting point of first solder layer 4a is higher than the melting point of second solder layer 4b, no melting will take place when heat is applied.

Incidentally, the melting point of second metal layer 4b will not be limited a melting point lower than first solder layer 4a but any of the layers having the same melting point can be used. Even if the solder with the same melting point is adopted, first solder layer 4a will not be melted by the relevant application of heat. The reason thereof is as follows.

A gold pattern (not illustrated in the drawing) is formed on sub-mount 3. Heat for melting second solder layer 4b is transferred through sub-mount 3 to melt that gold pattern. When the gold pattern melts, it melts into first solder layer 4a. Thereby the gold content of first solder layer 4a will increase. Increase in the gold content will raise the melting point of first solder layer 4a. Thereby, the melting point of first solder layer 4a will become higher than that of second solder layer 4b and, therefore, will not melt when heat is applied to melt second solder layer 4b.

Lastly, sub-mount 3 and wiring layer 31 are brought into connection with wire 33 for wiring to complete electronic device 1.

Next, a schematic route for the transfer of heat generated in LED chip 2 in electronic device 1 of the present embodiment will be described.

Heat generated by operation of LED chip 2 is conducted at first through first solder layer 4a and then transferred to sub-mount 3.

The heat transferred to sub-mount 3 is conducted through second solder layer 4b, transferred to second metal layer 7 and then transferred to graphite layer 5. Thus, heat transfer from sub-mount 3 to graphite layer 5 is carried out by conduction through second solder layer 4b and second metal layer 7. In the case of the present embodiment, second metal layer 7 is provided on graphite layer 5. Thereby, a junction between heating structure 10 and heat releasing structure 20 using second solder layer 4b and having good heat conductivity can be created. Therefore, that enables thermal resistance between heating structure 10 and heat releasing structure 20 to be reduced as much as possible. Consequently, heat generated in LED chip 2 can be effectively transferred to graphite layer 5.

Heat transferred from LED chip 2 to graphite layer 5 in the stacking direction is conducted in the plane direction with graphite layer 5. Heat widely diffused in the plane direction with graphite layer 5 is transferred to first metal layer 6 and is efficiently diffused from the surface of first metal layer 6 into the air. Here, in the case where electronic device 1 is installed in another apparatus, the relevant apparatus is caused to function as a heat releasing member to enable the heat radiation area to become widened. For example, consider the case electronic device 1 is attached to the main body of a luminaire comprising a metal enclosure. In the case in which the side of first metal layer 6 is attached to the main body of the luminaire, heat will be transferred from first metal layer 6 to the main body of the luminaire and radiated from the surface of the main body of the luminaire into the air. Here, there likewise is the case where first metal layer 6 is attached to a radiating fin or to a heating pipe in order to enhance heat radiation efficiency.

Graphite layer 5 is caused to intervene between sub-mount 3 and first metal layer 6 to enhance the heat conductive property in the plane direction. Thereby, this will allow the effective heat radiation area of first metal layer 6 to become widened and therefore effective cooling of heating elements such as an LED and the like will become possible. However, because significant thermal resistance was left to intervene between heating structure 10 and heat releasing structure 20, as in the above described conventional example and the like, it could not take adequate advantage of the properties of graphite.

In contrast, in the patent application of the present invention, second metal layer 7, that has high wettability with solder, is formed on graphite layer 5. Thereby, junction between heating structure 10 and heat releasing structure 20 is realized with second solder layer 4b. Then, it becomes possible to maintain low thermal resistance between heating structure 10 and heat releasing structure 20. In addition, by adopting a metal film with high thermal conductivity for second metal layer 7, thermal resistance is kept lower.

Here, another configuration of the-present embodiment is illustrated in FIG. 4.

In the configuration illustrated in FIG. 3, LED chip 2 and sub-mount 3 were brought into junction with first solder layer 4a. In contrast, in the configuration of electronic device 1b illustrated in FIG. 4, LED chip 2 and sub-mount 3 are brought into flip-chip junction by bump 4d. Bump 4d can be a solder bump or a gold bump. Here, the configuration illustrated in FIG. 3 is likewise the configuration illustrated in FIG. 4 except that first solder layer 4a is replaced by bump 4d and the corresponding portions are designated by the same reference numbers as used in FIG. 3. Also in the present configuration, heat from LED chip 2 is transferred to sub-mount 3 through bump 4d. Thereafter heat travels along the route as described above and is radiated well.

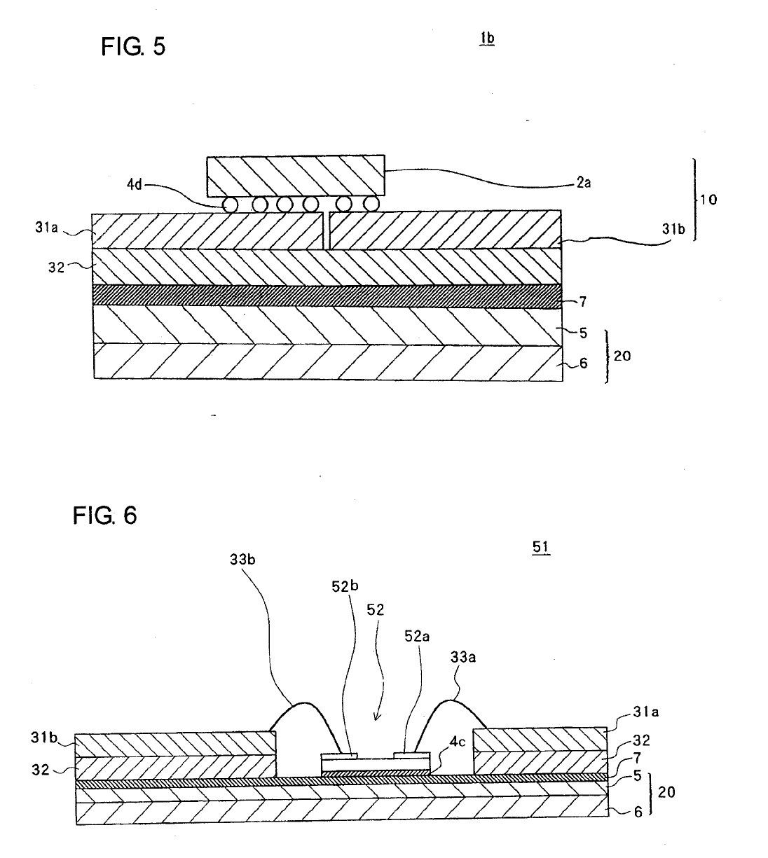

In addition, still another configuration of the present embodiment is illustrated in FIG. 5.

Each electronic device 1 in FIG. 3 and each electronic device 1 b FIG. 4 has LED chip 2. In contrast, electronic device 1c illustrated in FIG. 5 includes CPU 2a. That is, the present invention is applicable not only to an electronic device comprising an LED chip mounted on a wiring layer through a sub-mount but is also applicable to an electronic device comprising a CPU or an IC and the like brought into direct flip-chip junction by a bump on a wiring layer without intervention of a sub-mount.

As described above, according to the present embodiment, it is possible to take adequate advantage of high heat diffusion property of graphite in the plane direction. Therefore, desired cooling properties can be implemented in an electronic device.

### Second Embodiment

A schematic section illustrating configuration of electronic device 51 of the present embodiment is illustrated in FIG. 6.

As LED chip 52 of electronic device 51 of the present embodiment is configured by P pole 52a and N pole 52b provided on the upper plane and is mounted directly on second metal layer 7 without intervention of a sub-mount. Since the other basal configuration is the same as in the first embodiment described above, detailed description will be omitted.

On the lower plane of LED chip 52 where P pole 52a and N pole 52b are not provided, a plating layer (for example, gold plating) is formed so that there will be good solder wettability. LED chip 52 causes plane to face second metal layer 7 and is brought into junction by means of solder layer 4c. P pole 52a is electrically connected to first wiring layer 31a by first wiring wire 33a. In addition, N pole 52b is electrically connected to second wiring layer 31b by second wiring wire 33b.

The first embodiment was exemplified by a configuration suitable for mounted LED chip 2 comprising P pole (or N pole) on the upper plane and N pole (or P pole) on the lower plane. In the case of LED chip 2 where the P and N poles are arranged on the upper and the lower planes, it is necessary to insulate second metal layer 7 on heat releasing structure 20. Therefore, LED chip 2 which is mounted on sub-mount 3, is mounted onto second metal layer 7. Therefore, heat generated by LED chip 2 will be transferred to second metal layer 7 via first solder layer 4a, sub-mount 3 and second solder layer 4b.

In contrast, in the case of the present embodiment, as described above, P pole 52a and N pole 52b in LED chip 52 are formed on the upper plane of LED chip 52 and are not formed on the lower planer. Therefore, insulation by the sub-mount is not required. Also in the first embodiment, a sufficiently good heat radiation property is attainable. However, in the case of the present embodiment, LED chip 52 is mounted directly onto second metal layer 7 so that the sub-mount and first solder layer 4a can be omitted. Therefore, in the case of the present embodiment, thermal resistance from LED chip 52 to graphite layer 5 can be reduced. Therefore, it is possible to take sufficient advantage of the high heat diffusion property of graphite in the plane direction and, at the same time, better heat radiation can be achieved.

In addition, in the case of the first embodiment, a step for manufacturing heating structure 10 comprising LED chip 2 and sub-mount 3 that is brought into junction with first solder layer 4a is required. That is, steps for providing sub-mount 3 with first solder layer 4a, bringing first solder layer 4a into the melted state, integrating sub-mount 3 and LED chip 52 by cooling and solidifying first solder layer 4a after mounting LED chip 52 onto first solder layer 4a in the melted state are required.

In contrast, LED chip 52 of the present embodiment does not require the sub-mount and the first solder layer. Therefore, production of a heating structure is not required. Thereby, manufacturing steps can be simplified and also the number of parts in an apparatus can be reduced.

In addition, in the case of a heating structure comprising a sub-mount, it is necessary to extract the wiring wire from the sub-mount. Therefore, in order to secure the region for connection of the wiring wire, it is necessary to make the area of the sub-mount larger than the area of the LED chip. This causes the size of the apparatus to become larger. it is necessary to make the area of the sub-mount larger than the area of the LED chip, resulting in a larger size by that portion.

In contrast, chip 52 of the present embodiment requires the mounting area only for the portion of the LED chip. Therefore, it is possible to make an apparatus smaller.

As described above, according to the present embodiment, it is possible to take sufficient advantage of the high heat diffusion property of graphite in the plan direction. Therefore, desired cooling properties will become attainable in an electronic device.

Here, the configuration of the present embodiment is preferably configured by insulating the P pole and the N pole to function as the wiring extracting portion on the plane of the heating structure except for the plane where the LED chip contacts second metal layer 7. For example, in addition to the case where the P and N poles are present on the upper plane, the P and N poles can be formed on the side plane.

In addition, the present embodiment is exemplified by bringing the LED chip comprising a gold plating layer formed on the lower plane into junction with second metal layer 7 by means of solder layer 4c. However, in the case where no gold plating pattern is formed, a junction can be realized by using an adhesive.

### Third Embodiment

For the present embodiment, an electronic device comprises a graphite layer and a second metal layer to realize high heat conductivity. A method for manufacturing the electronic device comprising, in particular, a connector will be described. Here, in the following description, electronic device 1 illustrated in the first embodiment will be used as an example.

In a case in which the idea is to establish an electrical connection between another apparatus and electronic device 1, using an electric-wire to link wiring layer 31 of electric device 1 to the other apparatus can be considered. In that case, the electric wire will be soldered to wiring layer 31. However, as described above, electronic device 1 is highly heat conductive. Therefore, the heat of the soldering iron will be absorbed by electronic device 1 and there will be a failure in producing an adequate alloy layer, resulting in mechanically incomplete soldering. That is, a method of carrying out soldering onto wiring layer 31 will become substantially difficult.

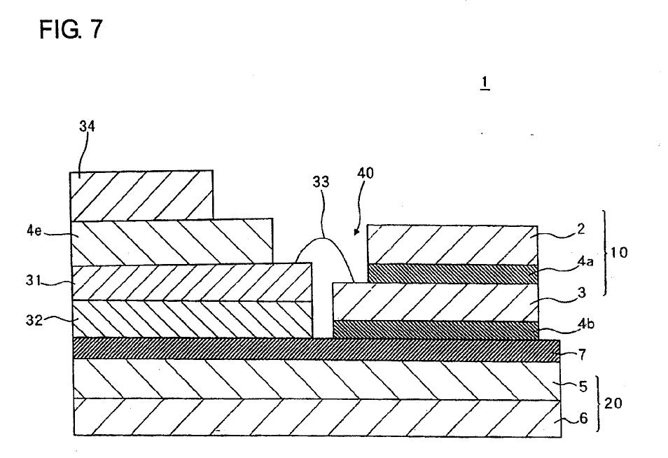

Therefore, as illustrated in FIG. 7, a method of mounting connector 34 onto wiring layer 31 using third solder layer 4e to intervene and inserting a plug to connector 34 hereof to establish electrical connection to the other apparatus can be considered. However, any attempt that will cause connector 34 to undergo reflow soldering onto electronic device 1, when the device comprises LED chip 2 which has already been mounted thereon, will not only melt third solder layer 4e, which is to be melted, but also first solder layer 4a. Then, displacement of LED chip 2 which has already undergone positioning will take place so that unendurable force will be applied for wiring wire 33.

Therefore, in the case of mounting a connector onto an electronic device of the present invention comprising the graphite layer and the second metal layer, the connector is preferably mounted by the following method.

At first, first solder layer 4a is formed on sub-mount 3. In addition, third solder layer 4e is formed on wiring layer 31 beforehand. Thus, after first solder layer 4a and third solder layer 4e are formed in advance, LED chip 2 is placed on first solder layer 4a and connector 34 is placed on third solder layer 4e. Subsequently, first solder layer 4a and third solder layer 4e are heated simultaneously. Thereby, LED chip 2 is soldered onto sub-mount 3 using first solder layer 4a. Concurrently, connector 34 is soldered onto wiring layer 31 using third solder layer 4e. Thus, simultaneous soldering LED chip 2 and connector 34 can prevent LED chip 2 that have been disposed in advance, from being displaced due to soldering to connector 34.

In addition, the following method can be adopted.

At first, connector 34 is soldered to wiring layer 31 in advance using third solder layer 4e to intervene. Next, LED chip 2 is placed on first solder layer 4a. In that state, heat is applied from the side of the rear plane (the plane where graphite layer 5 is not formed) of first metal layer 6. Then, heat is transferred to first solder layer 4a via graphite layer 5, second metal layer 7, second solder layer 4b and sub-mount 3 to melt first solder layer 4a so that LED chip 2 and sub-mount 3 are brought into junction. The heat that is used to heat first metal layer 6 from the rear plane side will be naturally transferred to third solder layer 4e as well. However, insulating layer 32 whose function is to provide significant thermal resistance is present between first metal layer 6 and third solder layer 4e. Therefore the time required for third solder layer 4e to begin to melt will become longer than the time required for first solder layer 4a to begin to melt and a time difference will occur between the times. That is, when using that time difference, the rear plane of first metal layer 6 is heated to melt first solder layer 4a and heating is stopped before third solder layer 4e starts to melt. Thereby, without melting third solder layer 4e which brings connector 34 into junction, LED chip 2 can be mounted.

In addition, the metal layer in each of the above described embodiments can be either a thin plate or a plating layer. In particular, in the case of a plating layer, the nickel layer can be formed beforehand so that a gold plating layer is formed thereon.

While preferred embodiments of the present invention have been described using specific terms, such description is for illustrative purposes only, and it is to be understood that changes and variations may be made without departing from the spirit or scope of the following claims.

What is claimed is:

1. An electronic device comprising:
a heating structure including a heating element, a pedestal for mounting said heating element thereon and a first connecting member containing metal for bringing said heating element and the pedestal into junction; and
a heat releasing structure including said first metal layer and a graphite layer stacked onto said first metal layer, wherein
a second metal layer is present on a plane in said graphite layer opposite to a plane where said first metal layer is stacked; and
said second metal layer and the pedestal are brought into junction with a second connecting member so that said heating structure and said heat releasing structure are thereby brought into junction, and said heating structure is mounted on the side of said graphite layer of said heat releasing structure.

2. The electronic device according to claim 1, wherein said second metal layer contains copper or aluminum.

3. The electronic device according to claim 1, wherein a surface on the side opposite to the side facing said graphite layer undergoes rust preventing treatment.

4. The electronic device according to claim 1, wherein said heating element is an LED.

5. The electronic device according to claim 1, wherein said heating element is a CPU or an IC.

6. The electronic device according to claim 1, wherein said first connecting member and said second connecting member are solder layers.

7. The electronic device according to claim 1, wherein said first connecting member is a solder bump or a gold bump.

8. The electronic device according to claim 1, wherein said melting point of said first connecting member is higher than said melting point of said second connecting member.

9. The electronic device according to claim 1, wherein the pedestal is made of AlN or SiC as the main material.

10. An electronic device comprising:
a heating element; and
a heat releasing structure including a first metal layer and a graphite layer stacked onto said first metal layer, wherein
a second metal layer is present on a plane in said graphite layer opposite to a plane where said first metal layer is stacked; and
a wiring layer formed on said second metal layer and said heating element are brought into junction by means of a solder bump or a gold bump, and said heating element is mounted on the side of said graphite layer of said heat releasing structure.

11. The electronic device according to claim 10, wherein said heating element is a CPU or an IC.

12. An electronic device comprising:
a heating electronic element having a wiring extracting portion; and
a heat releasing structure including a first metal layer and a graphite layer stacked onto said first metal layer, wherein
a second metal layer is present on a plane in said graphite layer opposite to a plane where said first metal layer is stacked;
said heating electronic element has a first plane where said wiring extracting portion is provided and a second plane where said wiring extracting portion is not provided;
said second metal layer and said second plane of said heating electronic element are brought into junction, and
said heating electronic element is mounted on the side of said graphite layer of said heat releasing structure.

13. The electronic device according to claim 12, wherein said heating electronic element is a semiconductor device and said wiring extracting portion is a P pole and an N pole where a wire for wiring is electrically connected.

14. The electronic device according to claim 13, wherein said semiconductor device is an LED.

15. The electronic device according to claim 12, wherein said second metal layer and said second plane are brought into junction by means of a solder layer.

16. A method for manufacturing an electronic device comprising a heating structure including a heating element, a pedestal for mounting said heating element thereon and a first connecting member containing metal for bringing said heating element and the pedestal into junction and a heat releasing structure including a first metal layer and a graphite layer stacked onto said first metal layer, wherein said heating structure and a connector are mounted on the side of said graphite layer of said heat releasing structure, said method comprising:
forming a second metal layer on a plane in said graphite layer opposite to a plane where said first metal layer is stacked and bringing said second metal layer and the pedestal into junction with a second connecting member containing metal; and
bringing said heating element into junction with said first connecting member on the pedestal on which said second metal layer and said second connecting member have been brought into junction, and concurrently bringing said connector into junction onto with a third connecting member containing metal on said heat releasing structure.

17. A method for manufacturing an electronic device comprising a heating structure including a heating element, a pedestal for mounting said heating element thereon and a first connecting member containing metal for bringing said heating element and the pedestal into junction and a heat releasing structure including a first metal layer and a graphite layer stacked onto said first metal layer, wherein said heating structure and a connector are mounted on the side of said graphite layer of said heat releasing structure, said method comprising:
forming a second metal layer on a plane in said graphite layer opposite to a plane where said first metal layer is stacked and bringing said second metal layer and the pedestal in junction with a second connecting member containing metal;
forming an insulating layer on said heat releasing structure;
forming a wiring layer on said insulating layer;
bringing said connector into junction onto said wiring layer with said third connecting member containing metal;
applying heat from the side of said first metal layer after said connector is brought into conjunction with said third connecting member onto said insulating layer to melt said first connecting member so that said heating element is brought into junction onto the pedestal; and
halting heat application from the side of said first metal layer before said third connecting member melts due to heat application from the side of said first metal layer.
